(19) United States
(12) Patent Application Publication
(10) Pub. No.: US 2018/0154584 A1
(43) Pub. Date: Jun. 7, 2018

(54) ADHESIVE DISPENSER AND A SHEATH-CONNECTION DEVICE INCLUDING SUCH A DISPENSER

(71) Applicant: SLEEVER INTERNATIONAL COMPANY, Morangis (FR)

(72) Inventor: Eric FRESNEL, Paris (FR)

(21) Appl. No.: 15/831,975

(22) Filed: Dec. 5, 2017

(30) Foreign Application Priority Data
Dec. 5, 2016 (FR) 16 61947

(51) Int. Cl. B29C 65/50; B29C 63/42; B29C 65/00

(52) U.S. Cl. CPC B29C 65/5042; B29C 63/42; B65H 35/0013; B29C 66/73715; B29C 65/5092

(57) ABSTRACT

The invention relates to an adhesive dispenser comprising:
a platform;
an unwinder reel pivotally mounted on the platform and designed to carry a roll of adhesive;
a separator member (9) for separating adhesive from the roll of adhesive, the separator member being arranged on the platform;
the adhesive dispenser comprising at least one embossing roller (18) arranged on the platform between the unwinder reel and the separator member so that, in operation, it embosses the adhesive tape (3) being unwound from the roll of adhesive before it reaches the separator member.

The invention also relates to a device for connecting together two flattened tubular sheaths including such an adhesive dispenser.

The invention relates to an adhesive dispenser.

The invention also relates to a device for connecting together two flattened tubular sheaths, which device includes such an adhesive dispenser.

### TECHNOLOGICAL BACKGROUND OF THE INVENTION

In the field of placing sleeves, such as heat-shrink sleeves, on traveling objects, the sleeves are generally obtained by cutting segments from a tubular sheath that is made available in a flat state in the form of a roll and then opened by a shaper prior to being cut transversely.

In view of the speeds of machines for placing sleeves on traveling objects, a recurrent problem that arises lies in changing the rolls when a roll has been entirely used up.

In relatively old techniques of the prior art, the two rolls were connected together manually.

However, given the very high speeds of machines for placing sleeves on traveling objects, that is no longer feasible.

More recently, it has been sought to automate the process of connecting sheaths together.

Document EP 2 825 370 thus discloses a device for connecting together two flattened tubular sheaths, the device comprising a carriage enabling a trailing end of an old sheath to be placed facing a leading end of a new sheath. In addition, the carriage includes an adhesive dispenser making it possible to stick the two ends together.

However, in document EP 2 825 370, the adhesive dispenser has a complex arrangement making it necessary in particular for the dispenser to include a blower for blowing on the adhesive strip of said dispenser so as to facilitate its removal.

### OBJECT OF THE INVENTION

The invention aims to provide an adhesive dispenser of structure that is simplified. The invention also provides a sheath-connection device including such a dispenser.

### PRESENTATION OF THE INVENTION

In order to achieve this aim, there is provided an adhesive dispenser comprising:

a platform;

an unwinder reel pivotally mounted on the platform and designed to carry a roll of adhesive;

a separator member for separating adhesive from the roll of adhesive, the separator member being arranged on the platform.

In the invention, the adhesive dispenser includes at least one embossing roller arranged on the platform between the unwinder reel and the separator member so that, in operation, it embosses an adhesive tape being unwound from the roll of adhesive before it reaches the separator member.

Thus, the adhesive tape is stiffened by deforming it by means of embossing before it reaches the separator member, which makes it possible for the adhesive itself to be stiffened and thus enabling it to be applied much more easily to an adhesive-receiving support.

The invention turns out to be particularly advantageous when a great length of adhesive must be applied to an adhesive-receiving support.

In particular manner, the separator member is shaped so as to present a base and a sharp tip extending from the base.

In particular manner, said sharp point is shaped as a chisel blade.

In particular manner, the chisel blade does not have teeth.

In particular manner, the separator member is shaped so that a first main face of the separator member in contact with the adhesive tape is plane.

In particular manner, the separator member is shaped so that a second main face of the separator member in contact with the support strip presents a change of slope forming a slope that is greater at the outlet of the separator member.

In particular manner, the embossing roller is shaped to form ribs in the adhesive tape.

In particular manner, the embossing roller has one to four circumferential disks.

In particular manner, the adhesive dispenser includes a cutter member for cutting adhesive of the roll of adhesive.

In particular manner, the adhesive dispenser includes a suction bar for carrying adhesive of the roll of adhesive.

The invention also provides a device for connecting together two flattened tubular sheaths, the device including such an adhesive dispenser in order to connect the two sheaths together.

Other characteristics and advantages of the invention appear on reading the following description of a particular, non-limiting embodiment of the invention.

### DESCRIPTION OF THE FIGURES

The invention can be better understood in the light of the following description given with reference to the figures of the accompanying drawings, in which:

FIG. 1 is a diagram showing an adhesive dispenser in a first embodiment of the invention;

FIG. 2 is an enlarged view of a portion of the dispenser shown in FIGS. 1; and

FIG. 3 is a diagrammatic plan view of an adhesive dispenser in a second embodiment of the invention.

### DETAILED DESCRIPTION OF EMBODIMENTS OF THE INVENTION

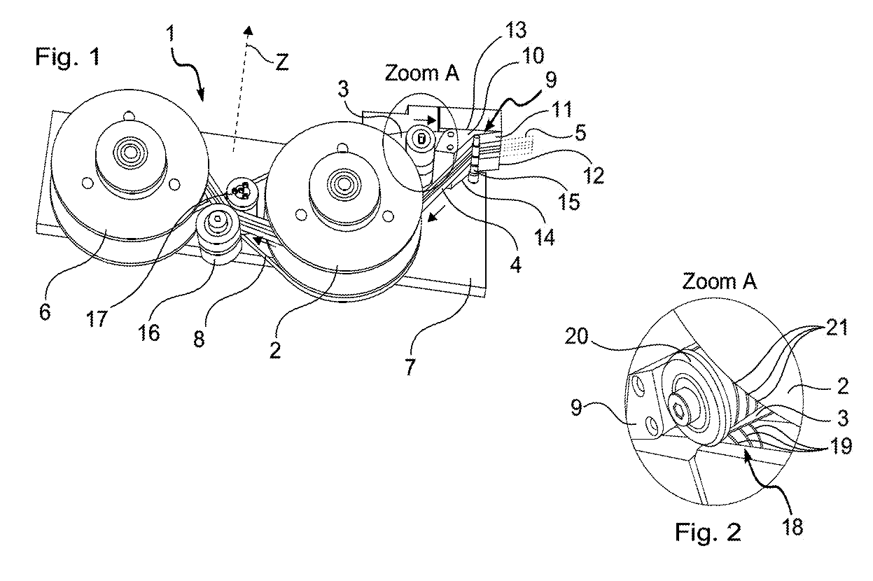

FIGS. 1 and 2 show an adhesive dispenser, given overall reference 1, in a first embodiment of the invention.

Such a dispenser 1 may be used in numerous applications and in particular in the field of devices for connecting together flattened tubular sheaths, typically heat-shrink sheaths. The present dispenser may thus be used in a device for connecting together flattened tubular sheaths such as that described in document EP 2 825 370.

With reference to FIG. 1, the dispenser 1 includes a platform 7 comprising a central portion that, in this embodiment, is substantially plane and rectangular in shape. The central portion thus has two main faces.

The dispenser 1 further includes an unwinder reel 2, on which there is mounted a roll of adhesive, in order to unwind the roll of adhesive. In this embodiment, the roll of adhesive comprises a support strip 4 on which there is arranged the adhesive 5 that is to cover an adhesive-receiving surface (typically one of the two flattened tubular sheaths to be connected together), the support strip 4 and the adhesive 5 together forming an adhesive tape 3.

Preferably, the adhesive 5 is a relatively rigid adhesive. The adhesive 5 is typically selected so that the adhesive 5 remains straight once it has been unwound over several centimeters, even after being peeled off the support strip 4.

By way of example, the adhesive 5 is thick or is a metal adhesive. By way of example, the adhesive 5 is an aluminum adhesive.

The dispenser 1 also comprises a winder reel 6 for re-winding the support strip 4.

The unwinder reel 2 and the winder reel 6 are typically arranged on a first main face of the platform 7 so as to be movable in rotation on the platform 7 about the axes of rotation that are parallel to each another and to a first direction Z. In this embodiment, the dispenser 1 is shaped so that the direction Z is substantially normal to the first main face of the platform 7.

In addition, the dispenser 1 is arranged in such a manner that the width of the adhesive tape 3, like the width of the adhesive 5 and of the support strip 4, extends parallel to the first direction Z once the roll of adhesive has been arranged in the dispenser 1.

Typically, the dispenser 1 includes a drive pulley 16 associated with a guide roller 17 that cooperate with each other in order to pull the support strip 4 so that it is unwound from the unwinder reel 2 and is rewound on the winder reel 6.

For this purpose, the drive pulley 16 is connected to rotary drive means that may optionally form part of the dispenser and that include a motor for example (the rotary drive means not being shown in this figure). The motor is typically servo-controlled so as to pull a (reprogrammable) given length of the support strip 4 in order consequently deliver a predetermined particular length of adhesive 5.

In this embodiment, the drive pulley 16 is mounted to pivot on the platform 7 about the first direction Z and is arranged on the platform 7 between the unwinder reel 2 and the winder reel 6. In addition, the guide roller 17 is arranged on the platform 7 between the unwinder reel 2 and the winder reel 6 and facing the drive pulley 16. By way of example, the guide roller 17 includes a slot that is substantially of the same width as the support strip 4, the support strip 4 being received in said slot during travel, thereby enabling the support strip 4 to be well pressed against the guide roller 17.

In particular manner, a belt 8 connects the unwinder reel 2 to the winder reel 6 in order to synchronize their rotation and facilitate pulling the support strip 4.

The dispenser 1 also includes a separator member 9 for separating the adhesive 5 onto the adhesive-receiving surface, which member is arranged on the platform 7 downstream from the unwinder reel 2 (in the travel direction of the adhesive tape 3 symbolized in the figure by an arrow). In this embodiment, the separator member 9 is shaped so as to present a base 10 and a sharp tip 11 extending from the base 10. The sharp tip 11 is shaped to form a chisel blade 12 at its free end. Preferably, the chisel blade 12 does not have teeth.

In addition, the separator member 9 is shaped so that a first main face 13 of the separator member in contact with the adhesive tape 3 is plane in order to facilitate unwinding of the adhesive tape 3.

Furthermore, the separator member 9 is shaped so that a second main face 14 of the separator member 9 that is in contact with the support strip 4 (after the adhesive 5 has been separated from its support strip 4 by the chisel blade 12 of the separator member 9) presents a change of slope between the return from the sharp tip 11 and the base 10, the base 10 thus presenting its second main face 14 with a slope that is much greater than the slope of the return from the sharp tip.

In order to facilitate affixing of the adhesive 5 onto the adhesive-receiving support, the dispenser 1 in this embodiment comprises a tensioning roller 15 arranged on the platform 7 at the separator member 9 in order to press the support strip 4 against the separator member 9. Preferably, the tensioning roller 15 is arranged at the change of slope of the second main face 14 of the separator member 9.

This makes it possible to press the support strip 4 well against the return from the sharp tip 11 with a small travel angle relative to the adhesive 5 that has just been peeled off. This facilitates detaching the adhesive 5 from its support strip 4.

By means of the change of slope, the support strip 4 is then quickly removed towards the winder reel 6 with considerable spacing apart from the adhesive tape 3 that continues to be unwound.

As shown more clearly in FIG. 2, the dispenser 1 includes an embossing roller 18 arranged on the platform 7 between the unwinder reel 2 and the separator member 9 (in the travel direction of the support strip 4). The embossing roller 18 is thus arranged at the outlet of the unwinder reel 2, i.e. where the adhesive tape 3 begins to travel in the dispenser 1.

In this embodiment, the embossing roller 18 is mounted to pivot on the platform 7 about the first direction Z.

Preferably, the embossing roller 18 is shaped to form ribs in the adhesive tape 3. To this end, as described, the embossing roller 18 has three disks 19 distributed in regular manner over the height of the embossing roller 18 (along the first direction Z) in order to form three corresponding ribs on the adhesive tape 3.

This makes it possible to stiffen the adhesive tape 3 and therefore both the support strip 4 and the adhesive 5. The ribs thus formed on the adhesive 5 make it possible to increase its natural stiffness. Once separated from its support strip 4, the adhesive 5 may thus be unwound for several centimeters without rolling up or collapsing.

The dispenser 1 includes a cavity roller 20 arranged on the platform 7 facing the embossing roller 18. The cavity roller 20 thus includes three circumferential slots 21 associated with respective ones of the disks 19 of the embossing roller 18 in order to facilitate formation of ribs in the adhesive tape 3.

In this embodiment, the cavity roller 20 is mounted to pivot on the platform 7 about the first direction Z.

The dispenser 1 is thus arranged so that when in operation, the adhesive tape 3 passes from the unwinder reel 2 to the separator member 9 by passing between the embossing roller 18 and the corresponding cavity roller 20. Thus pressed between the embossing roller 18 and the cavity roller 20, the adhesive tape 3 is fluted before reaching the separator member 9.

Then, the adhesive tape 3 surrounds the sharp tip 11 of said separator member 9. The shape of the sharp tip 11 causes the adhesive 5 to become detached from its support strip 4, substantially at the chisel blade 12 of the separator member 9.

The support strip 4 continues traveling alone along the return from the sharp tip 11, then once it has passed the tensioning roller 15, along the separator member 9 until it reaches the winder reel 6 so as to wind around the winder reel 6. Typically, the support strip 4 travels around the unwinder reel 2 before passing between the drive pulley 16 and the guide roller 17 and winding around the winder reel 6.

The dispenser 1 thus enables the adhesive tape 3 to be embossed before it reaches the separator member 9. The adhesive tape 3 is thus stiffened in simple and quick manner.

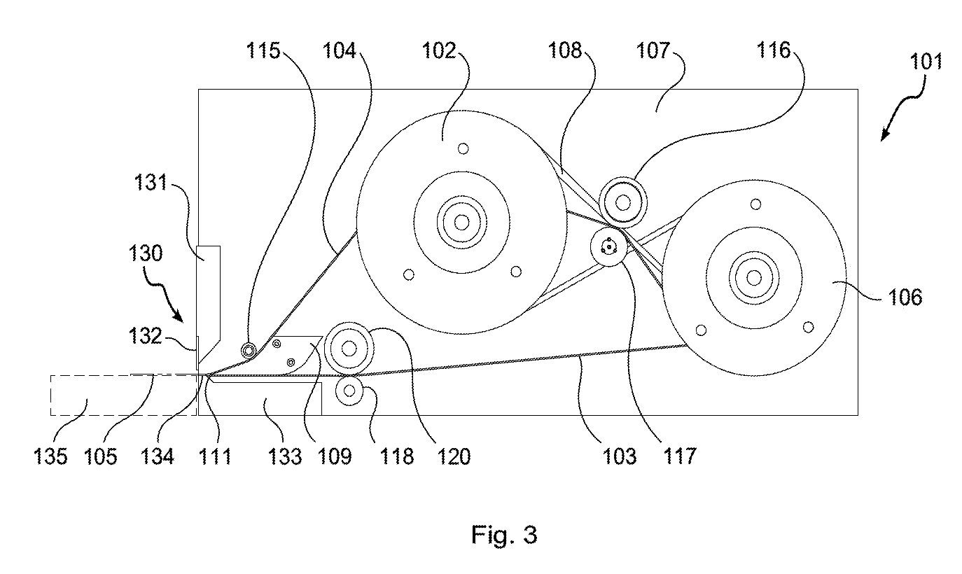

A second embodiment is described below with reference to FIG. 3. This second embodiment is identical to the first embodiment except that the platform 107 also includes a cutter member, given overall reference 130, for cutting the adhesive 105, once said adhesive has been separated from the support strip 104, in order to deliver the desired length of adhesive 105. In the first embodiment, the cutter member is typically carried by another portion of the general connection device.

To this end, the cutter member 130 comprises a first plate 131 that is arranged on the platform 107 at the sharp tip 111 of the separator member 109. The first plate 131 is provided with a chisel blade 132 mounted to slide on the first plate 131 between retracted position and a working position in which the blade 132 extends beyond the first plate 131 in order to cut the adhesive 105 that has just become detached from the support strip 104 at the sharp tip 111.

Preferably, the cutter member 130 also comprises a second plate 133 arranged facing the first plate 131 in order serve as backing when the blade 132 is cutting so as to facilitate cutting of the adhesive 105.

In this embodiment, the first plate 131 and the second plate 133 are also shaped to guide the adhesive 105 so that the adhesive 105 can be properly removed from the adhesive dispenser.

Typically, the two plates 131 and 133 are shaped so that at the blade 132, one of the plates has a finger 134 that is almost in contact with the other plate.

The connection device including this adhesive dispenser, typically includes a suction bar 135 (shown in this embodiment in dashed lines) arranged extending the cutter member 130 to ensure that the adhesive 105 is transmitted to the two tubular adhesive-receiving sheaths. Preferably, the suction bar 135 is mounted to move relative to the separator member 109 so as to facilitate the transfer of the adhesive 105 to the two adhesive-receiving sheaths.

In this embodiment, the suction bar 135 is also shaped so as to serve as backing when the blade 132 is cutting so as to facilitate cutting the adhesive 105.

In operation, the suction bar 135 is arranged in the immediate vicinity of the two plates 131 and 133.

The drive means drive the drive pulley 116 in rotation in order to pull the support strip 104.

At the separator member 109, the adhesive 5 detaches from the support strip 104 and is pushed towards the two plates 131 and 133, and is then guided by the plates 131 and 133 towards the suction bar 135. Because of its stiffness due to the embossing, it is relatively simple and easy to push and to guide the adhesive 105 until it reaches the suction bar 135.

Once the desired length of adhesive has been reached, the order is given to form a vacuum in the suction bar so as to press the adhesive 105 against the suction bar and then the order is given for the blade 132 to cut the adhesive 105. It should be observed that this cutting is relatively easy as a result of the good tension in the adhesive 105, in particular being pressed against the suction bar 135, as a result of the guidance between the two plates 131 and 133, and of the presence of the backing provided by the suction bar 135 and the second plate 133 (in this example together defining a slot into which the blade 132 may be inserted).

Then, once the adhesive 105 has been cut, the suction bar 135 can move to bring the adhesive to the two adhesive-receiving sheaths.

Cutting the adhesive 105 is thus simple and quick.

The invention is not limited to the description given above, but on the contrary it encompasses any variant coming within the ambit defined by the claims.

In particular, the embossing roller could be shaped differently from that which is indicated. By way of example, the embossing roller may have a single disk. A plurality of embossing rollers may extend concentrically parallel to the first direction Z, each embossing roller being shaped in the form of a disk, for example. Types of embossing other than ribs could be used to stiffen the adhesive strip and in particular the adhesive.

Furthermore, the numbers of tensioning rollers, guide rollers, embossing rollers, and cavity rollers may be different from those described above.

The dispenser may have a number of elements that is different from the number described above. The dispenser may thus directly include rotary drive means for driving the drive pulley of the support strip. The dispenser may directly include the suction bar. In the same way, the dispenser need not include the drive pulley and/or the corresponding guide roller, which could be carried by the remainder of the connection device.

1. An adhesive dispenser comprising:
a platform;
an unwinder reel pivotally mounted on the platform and designed to carry a roll of adhesive, the roll of adhesive including a support strip on which the adhesive is arranged, the strip and the adhesive together forming an adhesive tape;
a separator member for separating the adhesive from the support strip, the separator member being arranged on the platform;
the adhesive dispenser including at least one embossing roller arranged on the platform between the unwinder reel and the separator member so that, in operation, it embosses the adhesive tape being unwound from the roll of adhesive before it reaches the separator member in order to stiffen the adhesive tape.

2. The adhesive dispenser according to claim 1, wherein the separator member is shaped so as to present a base and a sharp tip extending from the base.

3. The adhesive dispenser according to claim 2, wherein the sharp tip is shaped to form a chisel blade at its free end.

4. The adhesive dispenser according to claim 3, wherein the chisel blade does not have teeth.

5. The adhesive dispenser according to claim 1, wherein the separator member is shaped so that a first main face of the separator member in contact with the adhesive tape is plane.

6. The adhesive dispenser according to claim 1, wherein the separator member is shaped so that a second main face of the separator member in contact with the support strip presents a change of slope forming a slope that is greater at the outlet of the separator member.

7. The adhesive dispenser according to claim 1, wherein the embossing roller is shaped to form ribs in the adhesive tape.

8. The adhesive dispenser according to claim 7, wherein the embossing roller has one to four circumferential disks.

9. The adhesive dispenser according to claim 1, including a cutter member for cutting adhesive of the roll of adhesive.

10. The adhesive dispenser according to claim 1, including a suction bar for carrying adhesive of the roll of adhesive.

11. The device for connecting together two flattened tubular sheaths, the device including an adhesive dispenser according to claim 1 in order to connect the two sheaths together.
